(19) United States
(12) Patent Application Publication
(10) Pub. No.: US 2007/0192086 A1
(43) Pub. Date: Aug. 16, 2007

(54) Perceptual quality based automatic parameter selection for data compression

(76) Inventors: Linfeng Guo, Cliffside Park, NJ (US); Yang Li, South Plainfield, NJ (US); Mark Sydorenko, New York, NY (US); Hua Zheng, Secaucus, NJ (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/352,952

(22) Filed: Feb. 13, 2006

(51) Int. Cl. G10L 19/00

(52) U.S. Cl. 704/200.1

(57) ABSTRACT

The automatic and optimal selection of coding parameter values according to analyses of coding trials is disclosed. The Neural Encoding Model (NEM) provides a method for providing a quantitative measure of the likelihood that a human observer can distinguish an original sensory signal from an approximation thereof, thus providing a metric by which the effect of various coding parameters may be analyzed and optimized. Optimal coding parameters can be defined for an entire data set, such as a digitized audio file, or for discrete portions of the data set. A trial coded data set or portion thereof is analyzed to determining if certain coding parameters have been assigned optimal values. If not, parameter manipulation is performed in an intelligent order and the objective analysis is repeated until predetermined objective perceptual distance criteria are achieved.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Ultimately, the goal of any media data compression implementation is to compress the amount of data required to represent an original signal while minimizing the impact on fidelity in the decompressed signal. For any given coding technique employed for media data compression, there are various parameters which can be optimized to achieve a desired level of compression for a given bit rate or to achieve an acceptable recovered signal.

Prior approaches to compression optimization have relied upon parameters computed from signal characteristics related to the intensity, envelope, transitional energy, etc. of the original signal. A desired set of coding parameters are defined according to the analyzed original signal. However, these prior approaches have not been capable of analyzing the resulting compressed signal with respect to an objective metric, either as a means to assess the acceptability of the compression or more significantly as a guide for recompressing the original signal, or signal fragment, with adjusted parameters.

### BRIEF SUMMARY OF THE INVENTION

U.S. Pat. No. 6,091,773 (Sydorenko), incorporated herein by reference, describes a method for measuring the perceptual distance between an original version of a sensory signal, such as an audio or video signal, and an approximate, reconstructed representation of the original sensory signal. The perceptual distance in this context is a direct quantitative measure of the likelihood that a human observer can distinguish the original audio or video signal from the reconstructed approximation to the original audio or video signal. The method is based on a theory of the neurophysiological limitations of human sensory perception. Specifically, a “Neural Encoding Model” (NEM) summarizes the manner in which sensory signals are represented in the human brain. The NEM is analyzed in the context of detection theory which provides a mathematical framework for statistically quantifying the detectability of differences in the neural representation arising from differences in sensory input. The described method does not involve either source model techniques or receiver model techniques based upon psychoacoustic or “masking” phenomena. Rather, the described method and apparatus provide a neurophysiologically-based receiver model that includes uniquely derived extensions from detection theory to quantify the perceptibility of perturbations (noise) in the approximately reconstructed signal.

The NEM model thus provides a metric by which the effect of various coding parameters may be analyzed and optimized. Unlike the prior art approaches to coding parameter selection, the presently disclosed invention does not base coding parameter selection solely on an analysis of a source data stream. Rather, the presently disclosed technique enables the automatic and optimal selection of values for parameters according to an analysis of coding trials in the context of perceptual distance analysis.

The objective analysis of the coding performance further enables the optimization of certain coding parameters not only for a given data set, such as for a digitized audio data file (e.g., a song file), but also for discrete portions of the data set. While certain prior art approaches apply different values for a particular parameter, such as window length, to different portions of a data set, the parameter values are chosen solely on a pre-processing analysis of the data set.

Thus, unlike the prior art which performs a pre-coding analysis of either the entire data set or its portions and determines coding parameters for the entire data set on the basis of that analysis, the presently disclosed invention is capable of performing an analysis of the coded data set or portions of the coded data set and determining if certain coding parameters have been assigned optimal values. If not, parameter manipulation is performed in an intelligent order and the objective analysis is repeated until either predetermined objective perceptual distance criteria are achieved or the measured perceptual distance is minimized, or both.

Specific embodiments of the presently disclosed invention include using NEM perceptual distance analysis on plural, discrete portions or “clips” of an audio file. For example, an audio file may be sampled for a given period (e.g. 0.75 seconds) at each of a given number of equally spaced intervals (e.g. six intervals). The sample clip is then coded and decoded to get a post-coded sample. The NEM technique is then used to establish the perceptual distance between the pre- and post-coded samples. The determination of perceptual distance can also be regarded as the establishment of an objective quality metric. In one embodiment, a target value for perceptual distance or quality is defined, along with a tolerance range. In another embodiment, the goal is to minimize the perceptual distance.

In a further embodiment of the presently disclosed invention, certain parameters are defined on the basis of an analysis of the entire source data set rather than a representative sample clip. For example, the step of determining the optimal size of a windowing function to be applied to a respective portion of a source data file prior to use of a transform function (e.g. Modified Discrete Cosine Transform (MDCT) transformation) is preferably performed for each block comprising the entire source data set. The block length is thus often referred to as the window length or window size. The consecutive blocks typically overlap each other by 50 percent.

The optimal window length for a particular block, and thus the coding quality, depends upon characteristics of the block. While the prior art has relied solely upon pre-coding analysis of the source data set for determining the appropriate window length, the presently disclosed invention performs an iterative, objective analysis of various window length settings in order to determine the optimal value for each block.

### BRIEF DESCRIPTION OF THE SEVERAL VIEWS OF THE DRAWINGS

The foregoing features of this invention as well as the invention itself may be more fully understood from the following detailed description of the drawings in which:

FIG. 1 is a schematic diagram of a Base Coder adapted for calculating a Neural Encoding Model perceptual distance or quality metric between an uncoded representation of a source data set and a coded representation of the source data set;

FIG. 2 illustrates an algorithm according to the presently disclosed invention for coder parameter optimization using the Base Coder of FIG. 1;

FIG. 3 illustrates a segment of the coder parameter optimization algorithm of FIG. 2;

FIG. 4 illustrates a further segment of the coder parameter optimization algorithm segment of FIG. 3;

FIG. 5 is a graph illustrating overlapping coding windows having the same length, as known in the art;

FIG. 6 is a graph illustrating overlapping coding windows of various window lengths defined as a result of pre-coding source analysis, as known in the art;

FIG. 7 is a graph illustrating how analysis windows are defined in the presently disclosed invention;

FIGS. 8A through 8C are graphs illustrating how coding windows are assigned to an analysis window according to the presently disclosed invention;

FIG. 9 illustrates a prior art approach to estimating optimal coding window lengths; and

FIG. 10 illustrates a method of determining optimal coding window lengths for an entire source data set, according to the presently disclosed invention.

### DETAILED DESCRIPTION OF THE INVENTION

A Neural Encoding Model (NEM) Audio Coder employs the NEM to compute an objective measure of perceived quality of the reconstructed source. For efficiency, a source data set is sampled to form a smaller, representative sample. The perceptual measure, referred to as a perceptual distance, is analyzed after initial encoding of the sample clip using a lossy coder and is employed in an algorithm for selecting optimal global coding parameters for the lossy coder. In a preferred embodiment, the sampling of the source data set into a sample clip, the determination of the respective perceptual distance, and the adjustment of global coding parameters is performed automatically.

According to one embodiment of the presently disclosed invention, a six second sample clip is utilized. The sample clip of this embodiment is comprised of nine segments extracted from the source data set at regular intervals, each being 0.75 seconds in length. For example, for a source data set of T seconds in length, the centers of the nine segments are located at T/10, 2T/10, 3T/10, . . . 9T/10, respectively.

Other algorithms are employable for deciding how many segments are required, for deciding when to capture segments, and for determining the duration of each segment. For instance, an alternative algorithm may determine the energy per standard time unit across an entire source data set. The segments having the highest and lowest relative energy may then be concatenated to form the representative sample clip. Alternatively, segments can be chosen based upon the concentration of energy per certain frequency bands, or other metrics. A further alternative is to perform the coding and perceptual quality determination using the entire source data set without sampling, though it has been established that accurate perceptual distance results can be obtained more efficiently through the use of smaller sample clips. Finally, a particular source data set may have certain coding parameters defined on the basis of a sample clip determined as described above, with another parameter, or parameters, defined using the entire source data set.

The sample is then coded with a first set of coding parameters, with other parameters temporarily fixed. The NEM Analyzer then processes the coded sample and measures the perceptual distance between the reconstructed coded sample and the uncoded original sample. The resulting distance is used to select the optimal parameter value, i.e. the parameter value that results in the lowest perceptual distance measurement or the parameter value that results in a distance measurement closest to a target value, depending upon the embodiment.

In the presently disclosed invention, three exemplary coding parameters are used: window type; window length; and high frequency cutoff. In signal processing, the spectral content of a signal is normally analyzed over a discrete time period. For example, a transform such as a Fourier transformation is applied to one or more finite time intervals of a waveform. A windowing function is often applied to the waveform prior to application of the respective transform. The NEM Audio Coder implementing the Lossy Coder can in specific realizations utilize a Time Domain Alias Canceling (TDAC) coding structure employing the Modified Discrete Cosine Transform (MDCT). This is a block based coding scheme in which each block is multiplied by a TDAC window before encoding.

A variety of windowing functions represent acceptable candidates for use in the NEM analysis. A coding block is not constrained to have the same length as the TDAC window; rather, the coding block can be decomposed into smaller, overlapping TDAC windows as understood by those skilled in the art.

Another one of the parameters to be optimized in the NEM lossy coder is the window length. Empirical evidence resulting from use of the NEM coder indicates that two suitable values are 90 ms and 180 ms. Other temporal values could also be used in alternative embodiments of the present invention.

A third parameter to be optimized is the high frequency cutoff value. When low bit-rate is used for encoding, the perceived quality of the reconstructed source also tends to be low as is reflected in the NEM perceptual distance. The perceptual distance between the coded content and the same content in the uncoded signal can be reduced if less high frequency content of the source is coded as compared to lower frequency content, even though, ideally, all of the high-frequency content would be kept as well. In the case of low-bit rate coding, a trade-off needs to be made as between the amount of high frequency content kept and the overall quality obtained. A frequency search algorithm, as described below, can automatically achieve the desired trade off.

As will be discussed below, it is important to determine the cutoff frequency that meets, but does not necessarily exceed, a target quality value while still satisfying a target bit rate (i.e. bit budget) criterion as well.

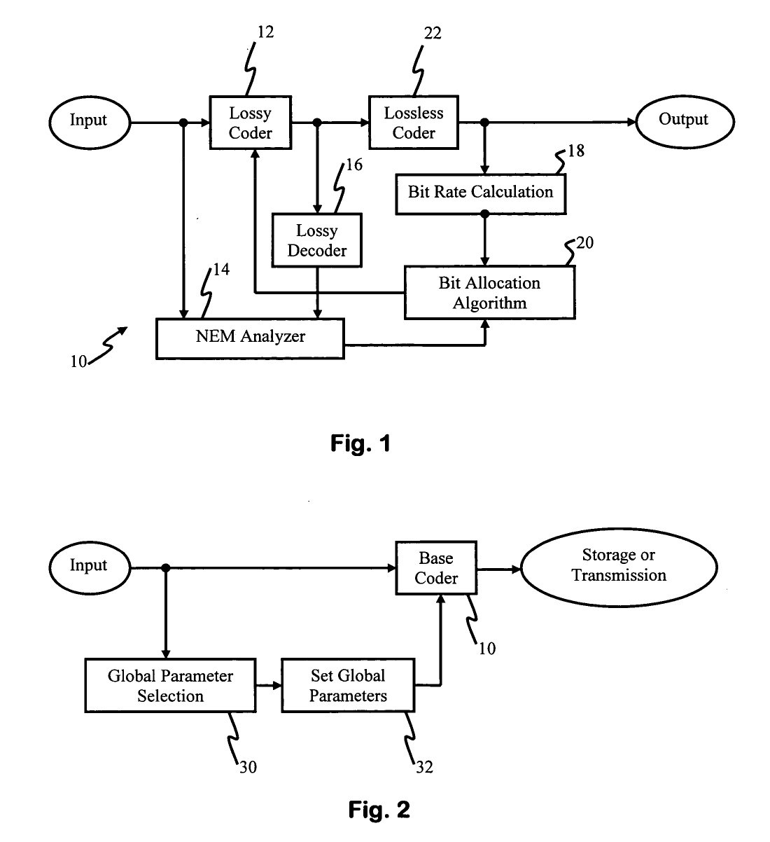

With reference to FIG. 1, a base coder 10 is illustrated in schematic form. Initially, the source data set is input to the Lossy Coder 12 having the parameters to be optimized. The output of the Lossy Coder 12 is normally processed by a Lossless Coder 22 prior to transmission or storage. In the case of a transmitted signal, a receiver (not illustrated) subjects the transmitted and received signal to a lossless decoder, which is the inverse of the Lossless Coder 22, followed by a lossy decoder. In the context of a music delivery service, the receiver may be a wireless phone or networked computer. Ignoring any transmission channel effects, the Lossy Decoder 16 in the base coder 10 provides a signal which is essentially identical to what would be recovered in a receiving device.

As described in U.S. Pat. No. 6,091,773, incorporated herein by reference, a measure of the perceptual distance between the coded and uncoded signals is made and either compared against a target value having a given threshold, or a value yielded by the same measure using an alternatively coded (i.e. alternate bit allocation) signal, or both. The output of the NEM Analyzer 14 is provided to a Bit Allocation Algorithm 20, where an attempt is made to optimize the allocation of bits needed to encode the source data set taking into consideration a bit rate measurement provided by a Bit Rate Calculation block 18. If a maximum bit rate threshold is in force, the algorithm attempts to distribute bits consistent with the bit budget (i.e. maximum bit rate) while still achieving an acceptable or minimal perceptual distance in the NEM Analyzer. If a maximum bit rate has not been established, then the Bit Allocation Algorithm employs enough bits to achieve a desired NEM goal without using excess bits that would not contribute to the perceived quality of the received signal.

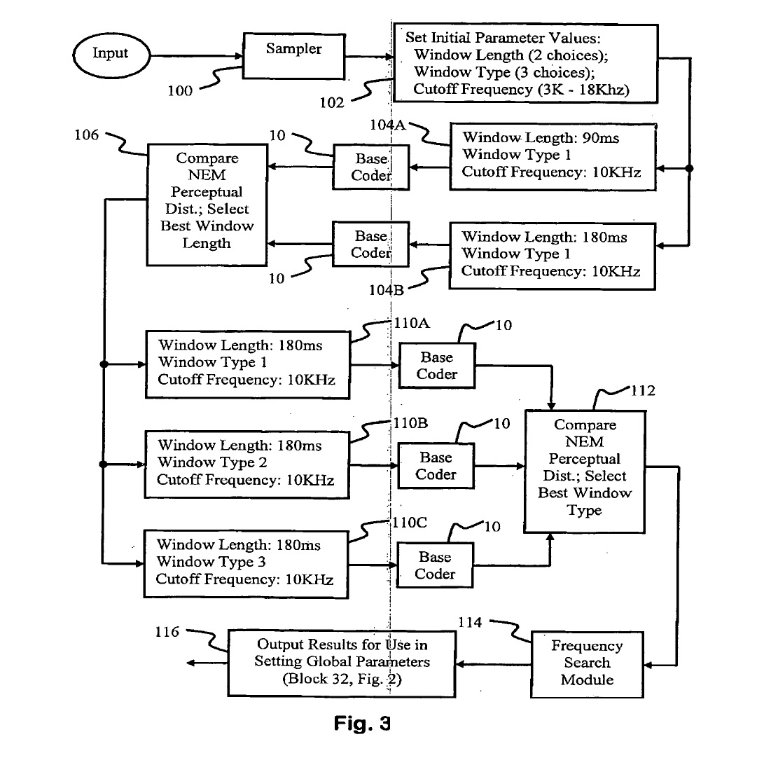

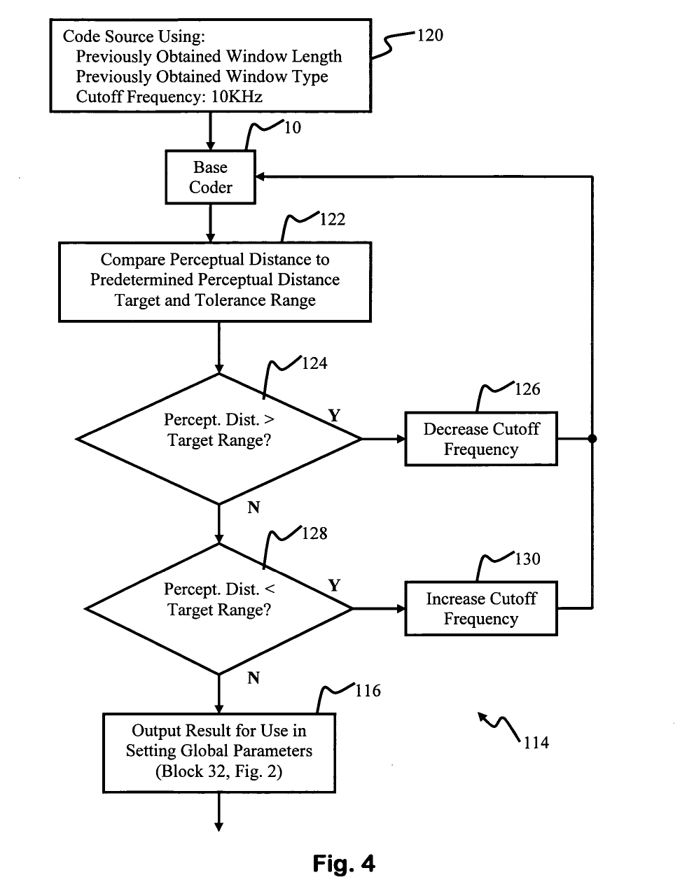

For the global parameter selection embodiment of the presently disclosed invention, FIG. 2 provides an overview of the process for determining optimal parameters for the Base Coder circuit of FIG. 1 generally and for the Lossy Coder 12 specifically. The process includes performing a Global Parameter Selection 30 based upon the input signal, otherwise referred to herein as the source data set, then defining the global parameters to be used, at block 32. These optimal parameter settings are then provided to the Base Coder 10, which uses these settings on the source data set. The output of the Base Coder 10 is then provided to storage, which can take any form including RAM, compact disk, digital video disk, smart card, etc., or to a transmitter, which can take any form including wireless RF, wireless IR, computer network interface (wired or optical), etc.

FIG. 3 portrays the function of the Global Parameter Selection block 30 of FIG. 2 in detail. An input signal, or source data set, is sampled 100, such as in the manner discussed in the foregoing, to form a sample clip. Initial values are defined for the parameters being optimized 102, which in the illustrated embodiment include window length, window type, and cutoff frequency. While parameter optimization can theoretically be approached in various orders, it has been empirically shown by the present inventors that a preferred order is to define the optimal window length, then the optimal window type, then the optimal cutoff frequency.

The sample clip is then processed by the Base Coder 10 with two different parameter sets, one in which the window length is set to 90 ms 104A and one in which the window length is set to 180 ms 104B. As shown in FIG. 1, the Base Coder 10 is comparing two sample clips in the NEM Analyzer 14: the sample clip as processed by the Lossy Coder 12 and the Lossy Decoder 16; and the original unprocessed sample clip. The result is a perceptual distance measurement for each value of Window Length 104A, 104B. The two measurements are compared and the window length setting that produces the minimum perceptual distance between the coded and decoded sample clip and the original sample clip is selected 106. In the exemplary scenario illustrated in FIG. 3, the sample clip processed with a window length of 180 ms has a lesser perceptual distance measure as compared to that processed with a window length of 90 ms.

A similar process for selecting the optimal window type is performed 110A, 110B, 110C. It is noted that the window length is set to 180 ms on the basis of the previous analysis 106. Sample clips are then processed by the Lossy Coder 12 and Lossy Decoder 16, both being part of the Base Coder 10. The results are then compared to an unprocessed sample clip in the NEM Analyzer 14 and the optimal window length, i.e. the one which provides the lesser perceptual distance, is selected 112.

An alternative approach to determining and defining window length is discussed below.

Optionally, the last parameter to be optimized is the cutoff frequency. This optimization occurs in a Frequency Search Module 114, which is detailed in FIG. 4. This module commences with a recognition that two of the three parameters have already been set 120. An initial cutoff frequency is defined. In FIG. 4, this value is chosen as 10 KHz. Empirically, this value should vary according to the encoding bit rate.

Once again, a sample clip is processed by the Lossy Coder 12 and Lossy Decoder 16, using the two previously established parameters, window length and window type, and using the selected starting point for cutoff frequency 120. The result from the Base Coder 10 is a perceptual distance. The resulting perceptual distance is compared against a target value and an associated tolerance range 122. If the perceptual distance is above the target range 124, then the cutoff frequency should be decreased to reduce coding contents 126. With a new, decreased value of cutoff frequency, another iteration through the Base Coder 10 occurs and the resulting perceptual distance is compared to the target value and tolerance range 122.

If the perceptual distance is below the target range 128, then the cutoff frequency should be increased to accommodate more content 130. Once this parameter change has been set, the sample clip is processed by the Base Coder 10 and the perceptual distance is again analyzed. This process repeats until a quality score that falls within the tolerance range is obtained. At this point, the optimized coder parameters are associated with the source data set and coder processing using the circuit of FIG. 1 can be performed.

In an alternative embodiment, the coding window length parameter is optimized for consecutive sub-segments of the entire source data set, where the entire portion of the source data within the sub-segment is substituted for the sample. This enables the use of window switching during source data set coding.

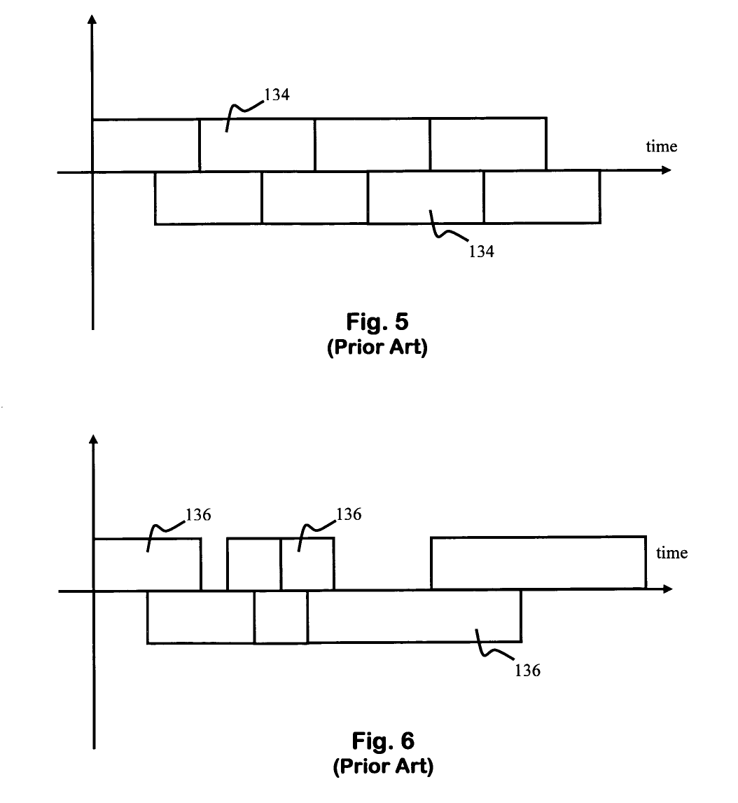

A simple approach to windowing a source data set prior to application of a transform function is to divide the source data set into equal, overlapping coding windows 134, such as illustrated in FIG. 5. The well-recognized draw-back associated with this static approach is that, for a given coding window length, coding performance varies greatly according to the respective content. As the transform length increases, frequency resolution increases and temporal resolution decreases. For example, coding a source data set segment that includes the clash of a cymbal with a long coding window can result in temporally displaced audio energy in a reconstructed data set. Conversely, too short a coding window can result in low frequency specificity, but with improved temporal specificity.

Thus, coding quality as a function of window length can vary greatly throughout a source data set since the optimal window size differs among various source data set contents. Therefore, it is desirable to use a window size that is optimal for the specific content to be coded.

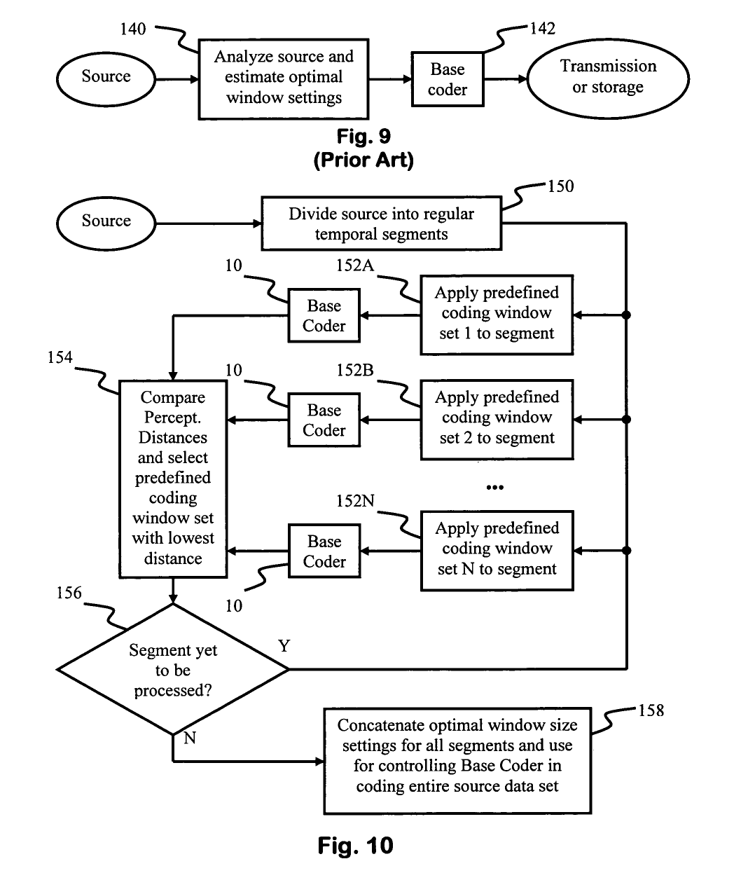

Window switching is a commonly used technique in TDAC based audio compression. As illustrated in FIG. 9, the prior art chooses coding window length 140 based upon a pre-coding analysis of factors including intensity, envelope, and transitional energy, among others, associated with the source data set. No trial coding is involved. After window settings have been estimated, the source data set is coded 142 using those setting and the coded data is ready for transmission and/or storage. FIG. 6 provides an example of coding windows of varying lengths 136 defined for a source data set on the basis of pre-coding analysis. The determined window lengths are estimations and in reality may not be optimal for the respective content.

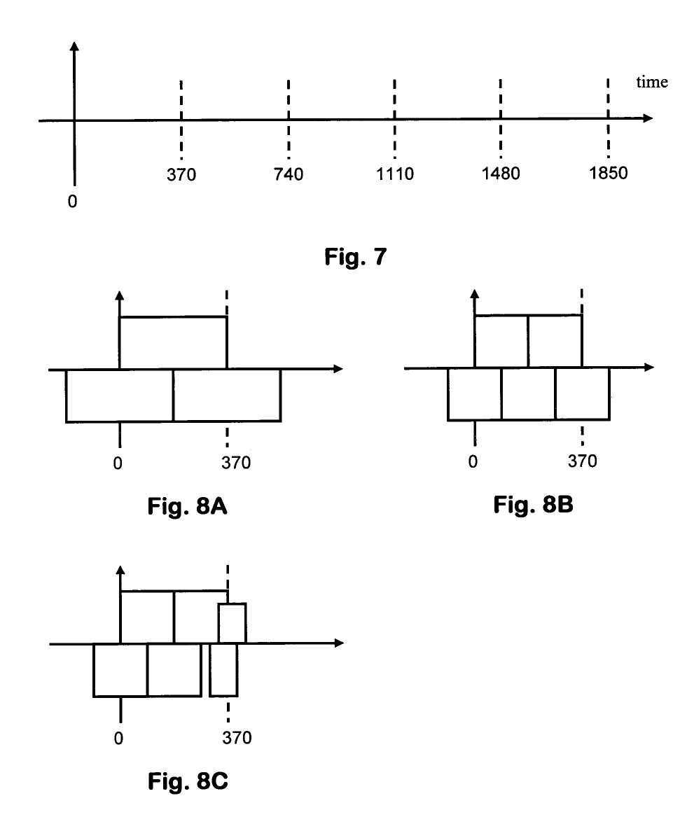

In contrast, the presently disclosed technique determines the optimal coding window size from among plural window length candidates for every source data set sub-segment being coded. This technique is diagrammed in FIG. 10. First, the source data set is divided into smaller segments 150 referred to herein as analysis windows. An exemplary value for the analysis window length (equivalently, sub-segment length) is 370 ms, though other values are possible. In defining the analysis window interval, a trade-off must be considered between accuracy and complexity. A longer analysis window means more coding window size settings, thus increasing coding complexity and time. A shorter analysis window constrains the number of coding window candidates, thus reducing accuracy in window size decisions. 370 ms is believed to provide a good balance between these competing considerations. FIG. 7 depicts an analysis timeline divided into 370 ms analysis windows.

In order to define the optimal coding window for a particular analysis window, the set of candidate coding window sizes must be defined. Empirical evidence suggests that, for an audio source sampled at 44.1 KHz, the following window sizes are suitable: 45 ms; 90 ms; 180 ms; and 370 ms. These window sizes correspond to the following number of sample points: 2048; 4096; 8192; and 16,384. Other values are employable.

These window sizes are then used for encoding each analysis window. The window sizes should be capable of covering each analysis window, either singly or in combination. Certain boundary conditions are dictated by TDAC for window switching, as is known to those skilled in the art. Thus, the coding window size settings may not exactly cover each analysis window, i.e., may not be exactly 370 ms or 16,384 sample points for sources sampled at 44.1 KHz. As a result, the starting point of the next analysis window cannot be decided until the coding window sizes has or have been decided for the presently considered analysis window. Even though the analysis windows are not evenly distributed across the source data set, this is not a concern for window switching or audio compression.

The following are six coding window sizes and combinations used in an exemplary embodiment of the presently disclosed invention in which each analysis window is approximately 370 ms wide:
{370 ms, 370 ms, 370 ms}—FIG. 8A
{180 ms, 180 ms, 180 ms, 180 ms, 180 ms}—FIG. 8B
{90 ms, 90 ms, 90 ms, 90 ms, 90 ms, 90 ms, 90 ms, 90 ms, 90 ms}
{45 ms, 45 ms, 45 ms, 45 ms, 45 ms, 45 ms, 45 ms, 45 ms, 45 ms, 45 ms, 45 ms, 45 ms, 45 ms, 45 ms, 45 ms, 45 ms, 45 ms}
{180 ms, 180 ms, 180 ms, 180 ms, 90 ms, 90 ms}—FIG. 8C
{90 ms, 90 ms, 180 ms, 180 ms, 180 ms, 180 ms}In FIG. 8C, the last 90 ms window is depicted shorter to illustrate the overlap with the fourth 180 ms window. As will be apparent to one skilled in the art, other coding window sizes and combinations are employable.

The following rules should be considered for deciding the window settings: 1) the ¼ point of the current coding window should be located at the ¾ point of the previous coding window; 2) the starting point of the second coding window should be aligned with the start of the respective analysis window; and 3) the end of the respective analysis window should fall within the first half of the last coding window. Enforcing these rules enables all parts of the analysis windows to be reliably coded and later reconstructed. As known in the art of TDAC, three consecutive coding blocks are required to fully reconstruct one block.

For a given analysis window, each of the candidate coding window sizes and combinations is applied 152A, 152B, 152N prior to encoding using the NEM Base Coder 10. As described above, an NEM perceptual distance analysis is performed for each window length candidate, and the coding window candidate that performs best is assigned to the respective portion of the source data set 154. Once all of the analysis windows comprising the entire source data set have been associated with respective optimal coding window candidates 156, the results are concatenated 158 for use in coding the entire source data set.

The presently disclosed invention can be implemented in software which, when properly adapted, can control the operation of a wide variety of computing devices, such as computers, signal processing boards, IC chips, etc. As noted, the source data set can be an audio file, a video file, or some other data type.

Having described preferred embodiments of the invention, it will now become apparent to one of ordinary skill in the art that other embodiments incorporating the concepts may be used. It is felt, therefore, that these embodiments should not be limited to disclosed embodiments but rather should be limited only by the spirit and scope of the appended claims.

1-2. (canceled)

3. A method for an objective determination of at least one coding parameter, comprising:
coding an original sample of an input signal using a lossy coder, having a coding parameter set to a first value of a plurality of trial values, to generate a coded sample;
decoding the coded sample using a lossy decoder to generate a decoded sample;
measuring a perceptual distance between the decoded sample and the original sample;
repeating the steps of coding the original sample, decoding the coded sample, and measuring the perceptual distance wherein the coding parameter is set to a respective, successive value of the plurality of trial values for each repetition; and
identifying the trial value resulting in an optimized perceptual distance as an optimal value for the coding parameter with respect to the original sample.

4. The method of claim 3 wherein the step of identifying further comprises identifying the trial value resulting in a minimum perceptual distance as the optimal value for the coding parameter.

5. The method of claim 3 wherein the step of identifying further comprises identifying the trial value resulting in a target value of the perceptual distance as the optimal value for the coding parameter.

6. The method of claim 3 wherein the step of identifying further comprises identifying the trial value resulting in a respective perceptual distance that is within a tolerance range.

7. The method of claim 3 further comprising a step of identifying the coding parameter from among plural candidate coding parameters based on the input signal.

8. The method of claim 7 wherein the plural candidate coding parameter comprise at least one from a group consisting of coding window length, window type, high frequency cut-off, bit rate, quantization method, and lossless coding method.

9. The method of claim 7 wherein the steps of coding, decoding, measuring, repeating, and identifying are repeated for each of plural coding parameters selected from the plural candidate coding parameters.

10. A method of optimizing a coding parameter in a lossy coder, comprising:
selecting at least one segment of an input signal;
selecting a first trial value for the coding parameter;
coding the at least one segment using the coding parameter to generate a coded segment;
decoding the coded segment to generate a decoded segment;
measuring a perceptual distance between the decoded segment and the corresponding at least one segment;
repeating the steps of coding the at least one segment, decoding the coded segment, and measuring the perceptual distance wherein the coding parameter is set to a respective, successive trial value for each repetition; and
identifying the trial value for the coding parameter resulting in an optimized perceptual distance as an optimal value for the coding parameter with respect to the at least one segment.

11. The method of claim 10 wherein the step of identifying further comprises identifying the trial value resulting in a minimum perceptual distance as the optimal value for the coding parameter.

12. The method of claim 10 wherein the step of identifying further comprises identifying the trial value resulting in a target value of the perceptual distance as the optimal value for the coding parameter.

13. The method of claim 10 further comprising a step of identifying the coding parameter from among plural candidate coding parameters based on the input signal.

14. The method of claim 10 wherein the coding parameter is a coding window length.

15. The method of claim 10 wherein the coding parameter is selected from the group consisting of a window type, a high frequency cut-off, a bit rate, a quantization method, and a lossless quantization method.

16. The method of claim 15 wherein the step of identifying comprises setting the cut-off frequency to jointly satisfy a target bit rate and a target perceptual distance.

17. The method of claim 10 wherein the at least one segment is comprised of plural temporally discrete sub-segments of the input signal.

18. The method of claim 17 wherein the step of selecting plural temporally discrete sub-segments comprises selecting the sub-segments based on spectral energy distribution for the sub-segment.

19. The method of claim 17 wherein the step of selecting plural temporally discrete sub-segments comprises selecting regularly spaced sub-segments, each of the same duration.

20. The method of claim 17 wherein the step of selecting plural temporally discrete sub-segments comprises selecting the sub-segments based on at least one physical characteristic for the sub-segment.

21. The method of claim 10 wherein the step of selecting at least one segment comprises selecting the at least one segment based on spectral energy distribution for the segment.

22. The method of claim 10 wherein the step of selecting at least one segment comprises selecting the at least one segment based on at least one physical characteristic of the at least one segment.

23. The method of claim 10 wherein the step of selecting at least one segment comprises selecting substantially all of the input signal.

24. An apparatus for optimizing at least one coding parameter utilized in a lossy coder, the apparatus comprising:
the lossy coder for receiving at least one portion of an input signal and for generating a coded signal therefrom utilizing the at least one coding parameter;
a lossy decoder connected to the lossy coder for receiving the coded signal and for generating a decoded signal therefrom; and
a neural encoding model analyzer connected to the lossy decoder and the lossy coder for receiving the input signal and the decoded signal, for calculating a perceptual distance therebetween, and for adjusting the at least one coding parameter based on the perceptual distance.

25. The apparatus of claim 24 wherein the neural encoding model analyzer is further for adjusting the at least one coding parameter to achieve a minimized perceptual distance.

26. The apparatus of claim 24 wherein the neural encoding model analyzer is further for adjusting the at least one coding parameter to achieve a target perceptual distance.

27. The apparatus of claim 24, wherein each of the at least one portion of an input signal is comprised of plural temporally discrete segments of the input signal.

28. The apparatus of claim 27, wherein the plural temporally discrete segments comprise segments selected based on spectral energy distribution for each segment.

29. The apparatus of claim 27, wherein the plural temporally discrete segments comprise regularly spaced segments, each of like duration.

30. The apparatus of claim 24, wherein the at least one portion of an input signal comprise portions selected based on spectral energy distribution for each portion.

31. The apparatus of claim 24, wherein the at least one portion comprises at least one portion selected based on at least one physical characteristic of the at least one portion.

32. The apparatus of claim 24, wherein the at least one portion comprises substantially all of the input signal.

33. The apparatus of claim 24 wherein the at least one coding parameter is selected from a group consisting of coding window length, window type, high frequency cut-off, bit rate, quantization method, and lossless coding method.

34. A computer-readable medium having stored thereon a plurality of instructions, the plurality of instructions including instructions which, when executed by a processor, cause the processor to perform the steps of:
coding an original sample of an input signal using a lossy coder, having a coding parameter set to a first value of a plurality of trial values, to generate a coded sample;
decoding the coded sample using a lossy decoder to generate a decoded sample;
measuring a perceptual distance between the decoded sample and the original sample;
repeating the steps of coding the original sample, decoding the coded sample, and measuring the perceptual distance wherein the coding parameter is set to a respective, successive value of the plurality of trial values for each repetition;
identifying the trial value resulting in an optimized perceptual distance as an optimal value for the coding parameter with respect to the original sample.

35. A computer-readable medium having stored thereon a plurality of instructions, the plurality of instructions including instructions which, when executed by a processor, cause the processor to perform the steps of:
selecting at least one segment of an input signal;
selecting a first trial value for a coding parameter;
coding the at least one segment using the coding parameter to generate a coded segment;
decoding the coded segment to generate a decoded segment;
measuring a perceptual distance between the decoded segment and the corresponding at least one segment;
repeating the steps of coding the at least one segment, decoding the coded segment, and measuring the perceptual distance wherein the coding parameter is set to a respective, successive trial value for each repetition; and
identifying the trial value for the coding parameter resulting in an optimized perceptual distance as an optimal value for the coding parameter with respect to the at least one segment.
